(19) United States
(12) Patent Application Publication
(10) Pub. No.: US 2026/0205038 A1
(43) Pub. Date: Jul. 16, 2026

(54) POWER SUPPLY METHOD FOR A STEPPER MOTOR AND DRIVE DEVICE FOR OPERATING THE LATTER

(71) Applicant: Carel Industries S.p.A., Brugine (PD) (IT)

(72) Inventors: Umberto Bianchini, Brugine (PD) (IT); Andrea Dalan, Brugine (PD) (IT)

(21) Appl. No.: 19/136,158

(22) PCT Filed: Dec. 5, 2023
(86) PCT No.: PCT/IB2023/062252

§ 371 Date: Jun. 5, 2025

(30) Foreign Application Priority Data
Dec. 5, 2022 (IT) 102022000024942

(51) Int. Cl. H02P 8/12; H02K 37/14; H02P 8/22; H02P 8/34

(52) U.S. Cl. CPC H02P 8/12; H02K 37/14; H02P 8/22; H02P 8/34

(57) ABSTRACT

Described is a method of supplying a stepper motor (10) which has the stator (12) provided with at least a first winding A1 (121) and at least a second winding (122) to be supplied in succession according to a power supply frequency. This power supply method provides for cyclically powering the first winding (121) and the second winding (122) in succession:—at an actuation voltage Va′ for a first power supply time ta1;—at a maintenance voltage Vm, lower than said actuation voltage Va′ for a second power supply time ta2; in such a way that the powered winding exerts a drive torque on the rotor (11) firstly to align it in accordance with the powered winding, during the first supply time ta1, and, subsequently, to keep it so aligned, during said second supply time ta2. The first supply time ta1 is set in such a way as to be substantially equal to an operating time t2−t1 which is equal to the time that elapses between an initial instant t1 of the application of the actuation voltage Va′ to the powered winding and an instant of rotation t2 in which the rotor (11) is aligned in accordance with the powered winding.

### TECHNICAL FIELD

The present invention relates to a method of supplying power to a stepper motor and to a driver device for operating the latter, particularly for the activation of an electronic expansion valve for a refrigeration cycle machine.

### BACKGROUND ART

Currently, in the field of the realization of precise actuators that can be actuated electrically or electronically, particularly for the activation of an electronic expansion valve for refrigeration cycle machines, the use of stepper motors is common, better known in jargon as stepper motors, that is, synchronous motors with permanent magnets.

This type of motor exerts a torque on the relative rotor in order to obtain predefined rotation steps of the latter so that the rotational displacement of the rotor, and therefore of the mechanical unit that it is designed to move, is directly related to the number of rotation steps carried out.

A stepper motor is driven by a controller, better known in the sector by the term “driver”, which, traditionally, can be of two types: unipolar or bipolar.

In general, moreover, the drivers can traditionally provide a “half step” or “full step” type of control.

In addition, the bipolar type drivers can actuate a type of “micro-stepping” control, that is to say, that involves actuating the rotor by means of a power supply of the stator windings that follows a trend of successive micro-steps that determines an accompanying effect of the rotor between the relative initial and final positions, within the single step.

In the text in the original language (Italian), in a manner consistent with the technical field in question, the term “passo”and the term “step” are used in a completely semantically overlapping and interchangeable manner, as is the term “stepper” and “passo-passo” referring to the electric motors in question, and this is equally valid for the terms “driver” and “controllore” unless the meaning of the related terms is otherwise specified.

In the case of a unipolar driver, the consumptions are determined by the impedance of the motor windings to be controlled, while for a bipolar driver, the consumptions are related to the current set by the driver itself.

In both cases, the power used is that necessary for the movement of the motor, that is to say, that provided for an effective rotation of the rotor with respect to the specific application for which it is intended.

Structurally, a bipolar driver consists of a more complex and costly circuitry solution than that for a unipolar driver but guarantees the possibility of having an independence from the impedance of the power cable and, therefore, allows longer cable lengths.

In addition, a driver that performs a micro-stepping actuation is less subject to step losses which, on the other hand, can be generated as a result of resonances generated by the system controlled in the other said actuation modes.

Stepper motors, therefore, are generally digital motors and their movement takes place by angular steps of rotation of the rotor.

Only in the position of the step is the system stable and, to maintain this stability, the motor must be kept powered continuously, that is to say, also between successive steps.

Therefore, in general and in a traditional manner, a stepper motor, except in the case of micro-stepping control, is powered by the relative driver according to two levels of power supply: a first level designed to actuate the rotation of the rotor by one step and a second level designed to ensure the maintenance of the alignment of the rotor between the steps of the same.

The motor, with the relative driver, therefore absorbs a step power, when the driver supplies the motor at the first level, that is to say, to promote the execution of a step of the rotor, and a holding power when the driver supplies the motor at the second level, that is to say, to keep the rotor in the position reached following a step.

Notoriously, the holding power is a percentage of the step power which, in general, varies indicatively between 10% and 30%, in nominal values.

In particular, in the case of control of an electronic valve of a refrigeration cycle machine, this is essential to guarantee a reliable maintenance of the position of the valve following the variation of the relative opening, corresponding to the step carried out by the motor.

### SUMMARY OF THE INVENTION

The problem underlying the present invention is therefore to optimize the operation of a traditional stepper motor by increasing the torque provided by the motor with the same power absorbed or reducing the power absorbed with the same torque provided by the motor, especially in the actuation of an electronic valve of a refrigerating circuit machine.

The task of a method of supplying power to a stepper motor and of a driver device for actuating the latter, according to the present invention, is therefore to solve this problem.

As part of this task, one aim of the invention is to propose a method of supplying power to a stepper motor and a driver device for actuating the latter that allows the power supply to the windings of the motor to be limited to that necessary to promote a relative step, allowing reduction of the consumption of the motor with the same torque provided.

Within this task, an aim of the invention is to create a method of supplying power to a stepper motor and a driver device to operate the latter that allows the supply time of the windings of the motor to be limited to that necessary to promote a relative step, allowing the torque provided by the motor to be increased with the same consumption of the motor with respect to the traditional solutions described above so as to increase the efficiency of actuation of an electronic valve of a refrigerating circuit machine that uses this motor.

Yet another aim of the present invention is to propose a method of supplying power to a stepper motor and a driver device for actuating the latter that allows said driver device to be miniaturized to reduce the overall dimensions of an electronic valve of a refrigerating circuit machine.

A further aim of the present invention is to provide a method of supplying power to a stepper motor and a driver device to actuate the latter that allows the thermal dissipation of the driver device to be reduced while maintaining the same operating efficiency of the latter.

This object, as well as these and other aims that will emerge more fully below, are achieved by a method of supplying power to a stepper motor and a driver device for actuating the latter according to the attached independent claims.

Detailed characteristics of a method of supplying power to a stepper motor and a driver device for actuating the latter according to the invention are set out in the dependent claims.

Further features and advantages of the invention will emerge more fully from the description of a preferred but not exclusive embodiment of a method of supplying power to a stepper motor and a driver device for actuating the latter, according to the invention, illustrated by way of non-limiting example in the accompanying drawings listed below.

### BRIEF DESCRIPTION OF THE DRAWINGS

FIG. 1 shows a schematic cross section view of a unipolar electric stepper motor;

FIG. 2 shows the traditional operating phases of the electric stepper motor schematically shown in FIG. 1;

FIGS. 3, 4 and 5 show, in a schematic form, examples of powering an electric stepper motor, in accordance with a powering method according to the present invention;

FIG. 6 illustrates current trends, with respect to the nominal ones, that occur during the operation of the motor referred to in this invention;

FIGS. 7a and 7b illustrate two simplified diagrams respectively of a unipolar motor and a two-pole motor on which a method according to the present invention can be adopted, the electronic symbols intend to represent the components traditionally known per se with each relative symbol.

### DETAILED DESCRIPTION

With particular reference to the above-mentioned drawing, a power supply method is disclosed, according to the present invention, which can be implemented to operate a stepper motor 10, that is, a permanent magnet synchronous motor of a traditional type which can be a unipolar or two-pole motor for operating an electronic valve of a refrigeration cycle machine.

Such a power suppling method can be implemented by a driver device, especially of an electronic valve of a refrigeration cycle machine, connected to the stepper motor 10 to operate it.

In general, and in a per se known manner, the driver device can be programmed or configured to actuate the electric motor according to alternative actuation modes known per se and in the jargon identified as “half-step” or “full-step”, which are not described further.

It should be noted that the present invention, although applicable to a solution operating in micro-stepping mode, having in this case a high number of voltage micro-steps would require a sampling of the back-EMF (Back Electro Motive Force) at a frequency comparable to that of the micro-stepping frequency and the magnitude of the voltage V of the step is small and equally small is the magnitude of the b-EMF which is therefore more difficult to detect accurately. However, the present invention is applicable to a micro-stepping device by solving the problem of simple underlying electrical logic, as identified above.

The stepper motor 10 may comprise a magnetic rotor 11 having an axis of rotation and a stator 12 housing the latter.

The stator 12 has at least a first winding 121 and at least a second winding 122 placed in sequence according to a direction circumferential to the axis of rotation, to be powered in succession according to a power frequency, so as to generate a drive torque on the rotor 11.

In a traditional manner, a method of powering a stepper motor comprises powering a winding, hereinafter referred to as “powered winding”:
at an actuation voltage Va for a first power supply time ta1;
at a maintenance voltage Vm, lower than said actuation voltage Va for a second power supply time;

The powered winding is, in succession and cyclically, the first winding 121 or the second winding 122, in such a way that, following the supplying at the actuation voltage Va of the powered winding, the stator 12 exerts a driving torque on the rotor 11, firstly to align it in accordance with the powered winding, during the first supply time ta1, and, subsequently, to maintain it in such alignment, during the second supply time ta2.

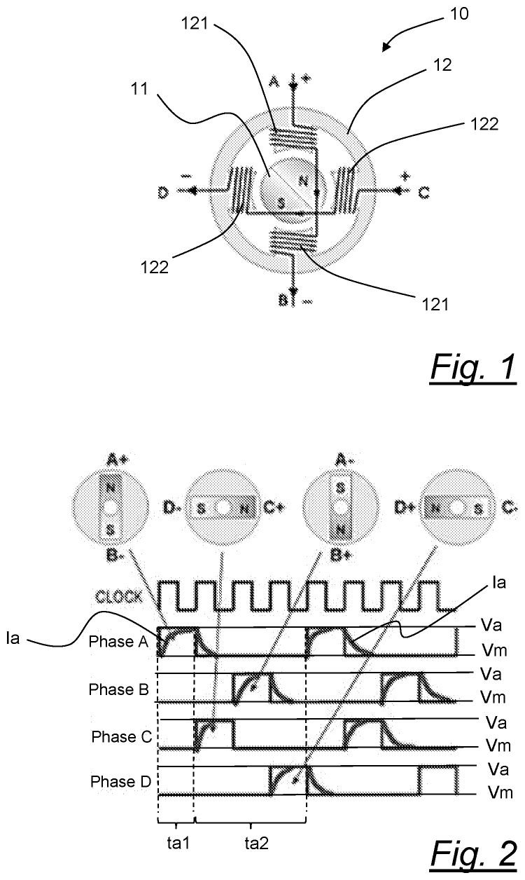

FIG. 2 illustrates by way of example a supply sequence, in itself traditional, of the motor schematically shown in FIG. 1, where the sequential supply of the first winding 121 and the second winding 122 is represented with reference to the four phases from A to D, in a manner in itself traditional.

FIG. 2 shows the first supply time ta1 and the second supply time ta2 with reference only to phase A, which clearly applies, as applicable, for the further phases B, C and D.

This figure also schematically shows the trend profiles of the winding current la that flows in the first and second windings 121 and 122 following the application of the actuation voltage Va and the maintenance voltage Vm.

It can be seen how each of the first and second windings 121 and 122 is cyclically supplied with an actuation voltage Va and a maintenance voltage Vm with consequent generation of the variation of the winding current la flowing in the respective first and second windings 121 and 122, in a conventional manner. The example of FIG. 2 shows the traditional actuation of first and second windings 121 and 122 cyclically supplied at the actuation voltage Va and at the maintenance voltage Vm for supply times ta1 and ta2 fixed in a traditional manner.

FIG. 2 shows how this traditional actuation generates a corresponding variation of the winding current la (the references of which are shown in relation to phase A only, to facilitate the understanding of the diagram) to generate the actuation sequence of phases A, B, C and D with corresponding rotation of the rotor 11 in the stator 12, shown in the upper part of FIG. 2.

Unlike such a traditional solution, in order to drastically increase the drive efficiency, according to the present invention, the first supply time ta1 is set in such a way as to be substantially equal to an operating time t2-t1 which is equal to the time that elapses between an initial instant t1 of the application of the actuation voltage Va to the powered winding and an instant of rotation t2 in which the rotor 11 is aligned in accordance with the powered winding.

For example, the rotation instant t2 can be assumed as the instant in which the rotor has reached the next step or the instant.

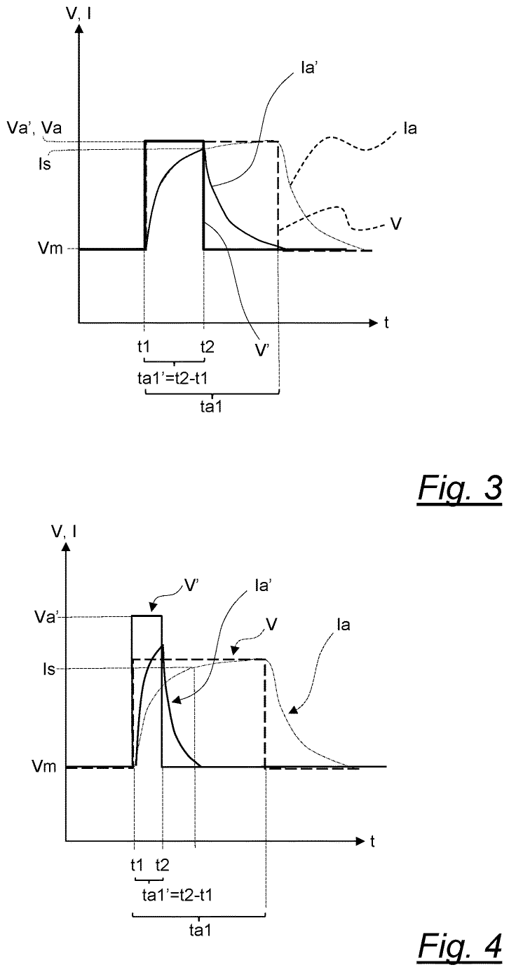

In other words, the rotation instant t2 can be the time instant in It is clear, therefore, how a power supply method according to the present invention allows the power supply efficiency of a stepper motor to be increased allowing the power absorption at the same torque provided to be reduced with respect to traditional solutions, as is immediately understandable from the diagram of FIG. 3 where the trend of the voltage V, applied to the powered winding, and of the current I, induced in the latter, are shown in a continuous line, where they derive from the implementation of a power supply method according to the present invention, and in a dashed line where they derive from a traditional actuation.

For convenience of description, in the following and in the attached drawings, quantities deriving from the use of a method for supplying power according to the present invention are identified by the addition of an apostrophe with respect to the homologous quantities deriving from the application of a traditional actuation device.

Thus, ta1′ represents the first supply time at the actuation voltage Va′ of the winding powered in accordance with a power supply method according to the present invention, wherein ta1 and Va represent, respectively, the first supply time at the actuation voltage in a conventional actuation device.

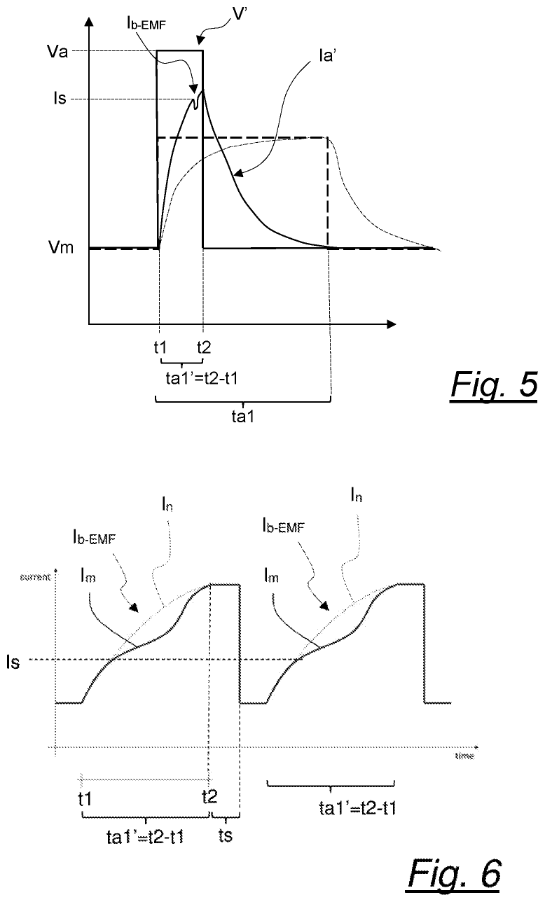

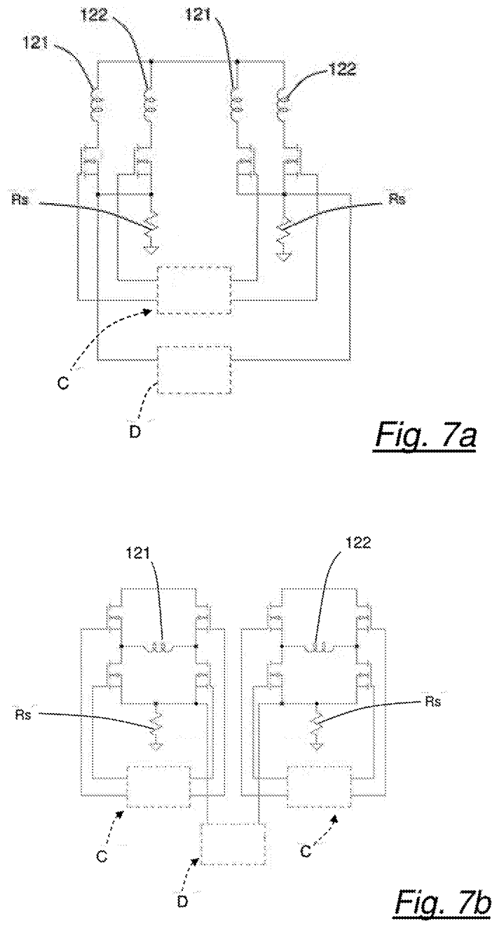

From the examples of FIG. 3 and FIGS. 4 and 5, it is possible to understand how the use of a supply method according to the present invention allows the power absorbed to be reduced at the same torque delivered by the motor 10, as for example can be seen in FIG. 4, or to obtain a greater torque delivered by the motor 10, at the same power absorbed, compared to the traditional solutions, as for example can be seen in FIGS. 5 and 6.

This makes it possible to obtain a refrigeration cycle machine valve, actuated by the motor that results in lower electricity consumption and, as will be seen below, possibly more compact, while guaranteeing a precision and reliability of opening and closing which is at least equal to traditional valves.

With particular reference to the examples of FIGS. 3 and 4, therefore, the first supply time ta1 at the actuation voltage Va is drastically reduced to the value of the operating time ta1′=t2−t1, where the instant of rotation t2 corresponds to the moment when the rotor performs a rotation step.

The instant of rotation t2 can be determined by means of a detection step that provides for a detection of a B-EMF (Back Electro Motive Force) which consists of an inverse peak of electromotive force, that is to say, an electromotive force opposite to that aimed at generating the actuation voltage Va.

Said detection step, which can be carried out for example by measuring current for example at a shunt resister or using the Hall effect, is designed to detect said B-EMF resulting from an orientation of the rotor 11 in accordance with the powered winding.

In other words, the detection step is designed to detect, directly or indirectly, a fluctuation of magnetic field generated by the alignment of the rotor with the powered winding.

This achieves the significant advantage of making the detection or step of the motor, which corresponds to the occurrence of a B-EMF, substantially insensitive to specific thermal and mechanical conditions of the motor and of its operation. This detection step may provide for a monitoring of an electric current flowing in the first and/or second winding 121, 122 to detect the B-EMF by detecting a fluctuation of said current, as per the example shown in FIG. 6.

The detection step, in particular, may comprise a monitoring of the electric current flowing in one of the first 121 or the second winding 122 which is not the powered winding.

In particular, according to the present method it is possible to detect said current fluctuation at a shunt resistor that is positioned in series with the first 121 or the second winding 122.

This solution allows the costs of the apparatus to be reduced as adding a shunt resistor in the unipolar motor allows the structure of the circuit to be maintained particularly simple, to the benefit of the relative cost.

On the other hand, in the case of a bipolar motor, the shunt resistor is already provided in the motor itself which-therefore-does not require modifications of the same, to the advantage of the structural simplicity of the same.

In addition, the solution of detecting a current difference or fluctuation at the shunt resistor Rs makes it possible to avoid problems with the polarity of the current flow.

In particular, the present method may comprise a discrimination step in which the trend of the electric current flowing in the first and/or second winding 121, 122 is analyzed.

This discrimination step may comprise detecting a difference or-trend deviation
of a current passing through the first winding 121 and/or the second winding 122; between:
a nominal current In which corresponds to an electric current passing through the first winding 121 and/or the second winding 122, and preferably the shunt resistor Rs, if there is no significant movement of the rotor 11, for example of its alignment in accordance with the powered winding 121 or 122;
a modified current Im corresponding to an electric current passing through the first winding 121 and/or the second winding 122, and preferably the shunt resistor Rs, upon the occurrence of a back electromotive force due to an alignment of the rotor 11 in accordance with the powered winding, for example as shown in FIG. 6.

The fluctuation Ib-EMF can be given, in particular, by a deviation of the modified current Im from the nominal current In evaluated by a discrimination algorithm by a discriminating device D which can be integrated in the controller device C and which can detect said deviation of current flowing through the shunt resistor Rs. This discrimination step may comprise, following the detection of said modified current, reducing the supply voltage of the powered winding from the actuation voltage Va′ to the maintenance voltage Vm.

If necessary, a delay time ts can be provided, after the operating time t2−t1, which elapses before the reduction of the supply voltage of the winding powered from the actuation voltage Va′ to the maintenance voltage Vm.

Preferably, said discrimination step is implemented by detecting said current which flows through a resistor Rs, for example a shunt resistor, which is in series with both the first winding 121 and the second winding 122 so as to detect said current regardless of which of the first winding 121 and the second winding 122 is the powered winding.

In particular, the provision of the discrimination step allows the present method to be rendered insensitive to boundary conditions such as temperature variations or resulting from mechanical effects of the valve.

In this way, the discrimination step, implemented according to the present method, allows the detection-without being affected by the specific characteristics of the motor to which it is applied-of a divergence of the current flowing in the shunt resistor between an undisturbed flow condition and a condition in which the flow suffers the effect of the B-EMF deriving from the rotation of the rotor.

For example, a solution that provided a voltage threshold definition to detect the occurrence of the B-EMF given by the alignment of the rotor 11 in accordance with the powered winding, would be sensitive to temperature effects that would determine a variation of the threshold, unlike the solution according to the present method.

The use of the shunt resistor Rs, in series with the first winding 121 and the second winding 122, also allows a uniqueness of direction of current flow to be obtained, which allows technical compromises to be avoided that would be-on the other hand-required to operate by means of a detection based on an average voltage threshold level.

In particular, according to the present method, this detection step may be carried out with substantial continuity during the supply of the actuation voltage Va′.

Where the term continuous detection may be understood as a detection carried out with a sampling, for example at a high frequency, during the supply of the actuation voltage Va′.

Such monitoring is preferably carried out on that, between the first and second winding 121, 122, which is not the powered winding.

Such monitoring may be used for detecting an Ib-EMF fluctuation of electric current that occurs as a consequence of the B-EMF, in a known manner.

The detection step can be followed by a reduction step that provides for reducing an electrical power absorbed by the at least one powered winding with respect to the maximum power absorbed by it during the operating time t2−t1.

This reduction step can be implemented by one or more of the following actions:
reducing an electric voltage V'applied to said at least one powered winding from a value equal to the actuation voltage Va′ to a value equal to the maintenance voltage Vm;

increasing an electrical resistance of the powered winding, for example by inserting a resistor in series with the latter for example by inserting a shunt resistor (Rs) in series with it;
reducing an effective voltage of the powered winding by means of a PWM modulation.

In a known manner, a stepper motor 10 has a configuration that determines a threshold value Is for a current that flows through the powered winding that is such that when it is reached or exceeded, a magnetic flux is generated by the powered winding whereby the rotor 11 experiences a torque sufficient to determine an alignment in accordance with the powered winding.

Where “alignment” means an alignment of the axis of the coils.

The actuation voltage Va′ according to the present power supply method may be selected together with the first actuation time ta1′ in such a way that the pair of values of the actuation voltage Va′ and the actuation time ta1′, is such as to minimize a power absorption of the stepper motor 10 during the execution of the power supply method, or may be selected to maximize the torque exerted by the powered winding on the rotor 11.

Clearly, ta1′ is linked to the selection of Va′ in order to determine a current in the windings of the motor which is suitable to determine the making of a stepper motor. That is to say, the selection of Va′ and ta1′ is in any case such that in time ta1′, the application of Va′, depending on the contingent characteristics of the motor, the current to the windings is sufficient to generate a torque such as to induce a step of the motor.

In other words, within the limits of selection of Va′ given by the contingent tolerability characteristics of the motor in the specific application, ta1′ minimized in order to reach the current suitable to generate a step of the motor.

In other words, once the actuation voltage Va′ is selected for the specific application, a supply time ta1′ can be chosen in such a way as to minimize a power absorption of the stepper motor 10 during the execution of the power supply method, or it can be selected to maximize the torque exerted by the powered winding on the rotor 11.

As mentioned above, these two options are illustrated by way of example in FIGS. 3 and 4-5, respectively.

In the first case, as for example in FIG. 3, at the same actuation voltage Va′=Va, compared to a traditional solution, the power is drastically reduced by reducing the first actuation time, which is reduced from the traditional value ta1 to the lower value ta1′ in accordance with the present power supply method.

In the second case, as for example in FIG. 4 or 5, for example with the same power absorbed by the motor 10, the actuation voltage is increased Va′>Va and the actuation time correspondingly reduced ta1′<ta1, thus significantly increasing the drive torque.

Especially for applications that provide an available power supply that corresponds to 24 V AC, which is typical of common industrial automation systems, a power supply method according to the present invention is particularly advantageous as it allows the thermal dissipation to be reduced, for example by using the non-leveled or regulated rectified current without needing a power supply device or regulator, for example it can allow the use of capacitors to be avoided which are used, in some traditional applications, to make a voltage buffer.

In other words, in accordance with the present invention, where a 24V AC power supply is available at 50 Hz with a motor designed to perform a step every 10 ms it is possible to use to obtain a supply voltage of the motor directly at the peak voltage, without the use of a regulator.

The present invention can therefore make it possible to use the 24V AC 50 Hz voltage normally available in industrial networks, without the need for voltage regulators, avoiding the relative electrical dissipation, and reducing the overall dimensions of the driver device.

Such capacitors, which for example can have a capacity of about 1000 microF, are in fact bulky and, by eliminating them, as is allowed by the adoption of a power supply method according to the present invention, it is possible to miniaturize a driver device that operates according to such a power supply method and thus integrate it directly into the body of the electric motor with the further advantage of reducing the physical distance between the controller device C and the windings, allowing easier recourse to the configuration of the unipolar stepper motor 10, which is notoriously simpler structurally and cheaper.

Therefore, the sum of the first supply time ta1 and the second supply time ta2 can be selected, for example, in such a way that the stepper motor 10 has the power supply frequency substantially equal to the frequency of a power supply network to which the stepper motor 10 is intended to be connected to be supplied. This sum can be substantially equal to the period of the power supply frequency, such as-in the case of a frequency of 50 Hz or 60 Hz-10 ms, or 16.67 ms, respectively.

In general, this sum can be substantially equal to the period of the contingent power supply frequency, so as to minimize or render superfluous the power supply devices, in particular the traditional rectifying capacitors for example of 1000 microF, thus allowing the miniaturization, that is, the reduction of the overall dimensions, mentioned above.

In fact, it would thus be possible to synchronize the step of the stepper motor 10 with the mains power supply frequency, such that the power absorption to create out the step would be synchronized with the peak voltage peak through the diodes or diode of the power supply driver device of the motor, allowing the capacity of the rectifying capacitors to be reduced, or ideally not to provide them, in any case allowing the driver device to be significantly miniaturized.

A driving device of a stepper motor 10 configured to implement a power supply method as described above is also an object of the present invention.

The driver device may limit the structural impact, for example the overall size, that is to say, significantly reduce the capacity, of capacitor elements having a capacitance greater than, for example, 15 μF.

This makes it possible to have an overall size compatible with its integration with an electric motor, that is, with the stepper motor 10.

The driver device may be configured to be integrated directly into the stepper motor to minimize a distance between the driver device itself and the first and second windings 121, 122.

Preferably the stepper motor 10 is a unipolar motor.

It is understood, therefore, how a method of supplying power to a stepper motor and a driver device to actuate the latter, according to the present invention, allow the task and the aims set to be achieved, allowing optimization of the operation of a traditional stepper motor by increasing the torque provided by the motor at the same power absorbed or reducing the power absorbed at the same torque provided by the motor.

In particular, a method of supplying power to a stepper motor and a driver device to actuate the latter, according to the present invention, allow the power supply of the windings of the motor to be limited to that strictly necessary to promote a step of the same motor, to the advantage of a net reduction in the consumption of the motor with the same torque provided.

A method of supplying power to a stepper motor and a driver device to actuate the latter, as disclosed herein, also allow the supply time of the windings of the motor to be limited to that necessary to promote a step of the same, allowing the torque provided by the motor to be increased with the same consumption of the motor compared to traditional solutions.

In addition, by reducing the time of application of the voltage, for example by passing from 24V to 30V, it is possible to reduce the thermal dissipation of the driver device while maintaining the same operating efficiency of the latter, in fact the dissipation is correlated with the square of the voltage where the torque, being linked to the current of the coils, is correlated with voltage.

A method of supplying power to a stepper motor and a driver device for actuating the latter also allows the miniaturization said driver device especially in the case of availability of a traditional 24 V AC power supply.

The invention thus conceived is susceptible to numerous modifications and variations, all of which fall within the scope of protection of the attached claims. Further, all details may be replaced by other technically equivalent elements. Where the operating and technical features mentioned are followed by signs or reference numbers, the signs or reference numbers have been used only with the aim of increasing the intelligibility of the description and claims themselves and, consequently, they do not constitute in any way a limitation to the interpretation of each element identified, purely by way of example, by the signs or reference numerals.

1. A method of supplying power to a stepper motor, said motor comprising a magnetic rotor having an axis of rotation and a stator which houses the latter; wherein said stator comprises at least a first winding and at least a second winding placed in sequence according to a direction circumferential to the axis of rotation to be powered in succession according to a power supply frequency, so as to generate a drive torque on the rotor; said method providing supplying a powered winding, which is in succession cyclically said at least one first winding and said at least one second winding:
at an actuation voltage Va′ for a first power supply time ta1;
at a maintenance voltage Vm, lower than said actuation voltage Va′ for a second power supply time ta2;
in such a way that, following the supply at the actuation voltage Va′ of said powered winding, said stator exerts a driving torque on said rotor first to orient it in accordance with said powered winding, during said first supply time ta1, and, subsequently, to keep it thus oriented, during said second supply time ta2;
wherein the first supply time ta1 is set in such a way as to be substantially equal to an operating time t2−t1 which is equal to the time which elapses between an initial instant t1 of the application of said actuation voltage Va′ to said powered winding and a rotation instant t2 in which said rotor is aligned in accordance with said powered winding;
wherein said rotation instant t2 is determined by means of a detection step which provides for a detection of a B-EMF which consists of a back electromotive force;
wherein said detection step is designed to detect said B-EMF deriving from an alignment of said rotor in accordance with said powered winding;
wherein said detection step provides for monitoring of an electric current flowing in said first or second winding to detect said B-EMF by detecting a fluctuation of said current.

2. The power supplying method for a stepper motor according to claim 1, wherein said detection step provides for monitoring an electric current flowing in one between the first winding or the second winding that is not the powered winding.

3. The power supplying method for a stepper motor according to claim 1, wherein said detection step is followed by a reduction step designed to reduce an electric power absorbed by said at least one powered winding with respect to the maximum power absorbed by the latter during said operating time t2-t1; wherein said reduction step can be chosen by one or more of the following actions:
reducing an electric voltage applied to said at least one powered winding from said actuation voltage Va′ to said maintenance voltage Vm;
increasing an electrical resistance of said at least one powered winding,
reducing an effective voltage of said at least one powered winding by means of a PWM modulation.

4. The power supplying method for a stepper motor according to claim 1, wherein said stepper motor has a configuration to which is correlated a threshold value Is for a current flowing through said at least one powered winding; wherein said threshold value Is is such that if a current flowing through said at least one powered winding reaches or exceeds said threshold value Is, a magnetic flux is generated by said powered winding, for which said rotor experiences a torque sufficient to determine an alignment in accordance with said at least one powered winding; wherein said threshold value Is of said current corresponds to a voltage step value; wherein said actuation voltage Va′ is chosen, as a function of said step value, to minimize a power absorption of said stepper motor during the execution of said power supply method or to maximize a torque exerted by said powered winding on the rotor.

5. The power supplying method for a stepper motor according to claim 1, wherein the sum of said first power supply time ta1 and said second power supply time ta2 is chosen in such a way that said stepper motor has said frequency substantially equal to the frequency of a power supply network to which said motor is intended to be connected in order to be powered by.

6. The power supplying method for a stepper motor according to claim 1, comprising a discrimination step which provides for detecting a difference-or deviation in trend-of a current which passes through the first winding or the second winding, between:
a nominal current In which corresponds to an electric current that passes through the first winding or the second winding if there is no significant movement of the rotor;
a modified current Im which corresponds to an electric current that passes through the first winding or the second winding upon the occurrence of a back electromotive force due to an alignment of the rotor in accordance with the powered winding.

7. The power supplying method according to claim 6, wherein said discrimination step provides for detecting a difference—or trend deviation—of a current which passes through a shunt resistor Rs which is in series with the first winding and with the second winding.

8. The power supplying method according to claim 6, wherein said discrimination step provides for detecting a difference—or trend deviation—Ib-EMF which is given by a deviation of the modified current Im from the nominal current In evaluated by a discrimination algorithm by a discriminating device which can be integrated in the controller device and which can detect said deviation of current flowing through the shunt resistor Rs.

9. A driver device for a stepper motor, configured to implement a power supplying method according to claim 1.

10. (canceled)

11. The driver device for a stepper motor according to claim 9, comprising a shunt resistor Rs in series with the first winding and with the second winding to which is connected a discriminating device designed to implement a discrimination algorithm configured to detect a difference—or trend deviation—Ib-EMF that is given by a deviation of a modified current Im from a nominal current In;
where
said nominal current In corresponds to an electric current that passes through the first winding or the second winding if there is no significant movement of the rotor; i.e. 122);
said modified current Im which corresponds to an electric current that passes through the first winding or the second winding upon the occurrence of a back electromotive force due to an alignment of the rotor in accordance with the powered winding.

12. The power supplying method for a stepper motor according to claim 2, wherein said detection step is followed by a reduction step designed to reduce an electric power absorbed by said at least one powered winding with respect to the maximum power absorbed by the latter during said operating time t2−t1; wherein said reduction step can be chosen by one or more of the following actions:
reducing an electric voltage applied to said at least one powered winding from said actuation voltage Va′ to said maintenance voltage Vm;
increasing an electrical resistance of said at least one powered winding;
reducing an effective voltage of said at least one powered winding by means of a PWM modulation.

13. A driver device for a stepper motor; configured to implement a power supplying method according to claim 5.

14. The driver device according to claim 13, including condenser members of limited capacity in such a way as to have an overall size compatible with their integration with an electric motor; wherein said driver device is configured to be integrated directly into said electric motor to minimize a distance between said driver and said at least a first and second winding.

15. The power supplying method according to claim 7, wherein said discrimination step provides for detecting a difference—or trend deviation—Ib-EMF which is given by a deviation of the modified current Im from the nominal current In evaluated by a discrimination algorithm by a discriminating device which can be integrated in the controller device and which can detect said deviation of current flowing through the shunt resistor Rs.

16. The driver device for a stepper motor according to claim 10, comprising a shunt resistor Rs in series with the first winding and with the second winding to which is connected a discriminating device designed to implement a discrimination algorithm configured to detect a difference—or trend deviation—Ib-EMF that is given by a deviation of a modified current Im from a nominal current In;
where
said nominal current In corresponds to an electric current that passes through the first winding or the second winding if there is no significant movement of the rotor;
said modified current Im which corresponds to an electric current that passes through the first winding or the second winding upon the occurrence of a back electromotive force due to an alignment of the rotor in accordance with the powered winding.

17. The power supplying method for a stepper motor according to claim 1, wherein the sum of said first power supply time ta1 and said second power supply time ta2 is chosen in such a way that said stepper motor has said frequency substantially equal to the frequency of a power supply network to which said motor is intended to be connected in order to be powered by; wherein said sum is substantially equal to 10 ms or 16.67 ms and wherein said frequency is substantially equal to 50 Hz or 60 Hz.

18. The driver device according to claim 13, including condenser members having a capacity not exceeding 15 μF, in such a way as to have an overall size compatible with their integration with an electric motor; wherein said driver device is configured to be integrated directly into said electric motor to minimize a distance between said driver and said at least a first and second winding; wherein said stepper motor is a single-pole motor.
